(19) United States
(12) Patent Application Publication
(10) Pub. No.: US 2021/0019745 A1
(43) Pub. Date: Jan. 21, 2021

(54) METHOD FOR VERIFYING A TRANSACTION IN A BLOCKCHAIN DATABASE

(71) Applicant: Idemia Identity & Security France, Courbevoie (FR)

(72) Inventor: Hervé CHABANNE, Courbevoie (FR)

(21) Appl. No.: 16/911,989

(22) Filed: Jun. 25, 2020

(30) Foreign Application Priority Data
Jul. 16, 2019 (FR) 1907996

(51) Int. Cl. G06Q 20/40; H04L 9/08; H04L 9/06

(52) U.S. Cl. CPC G06Q 20/401; G06Q 20/405; H04L 2209/38; H04L 9/0643; H04L 9/0869

(57) ABSTRACT

The present invention relates to a method for verifying a transaction in a blockchain database (3), the method being characterized in that it comprises the following steps:

(b) generation by a proof device (4) of a proof of the fact that there is a valid block published in said database (3), such as said block contains descriptive data of said transaction;
(c) transmission of at least said proof to a client device (2);
(d) verification by the client device (2) that the proof is valid.

### CROSS-REFERENCE TO RELATED APPLICATIONS

This specification is based upon and claims the benefit of priority from French patent application number FR 1907996 filed on Jul. 16, 2019, the entire contents of which are incorporated herein by reference.

### GENERAL TECHNICAL FIELD

The present invention relates to a method for verifying a transaction in a blockchain database.

### STATE OF THE ART

In recent years, blockchain databases have appeared.

A blockchain database is distributed among several storage nodes of a network. The storage nodes are configured to validate data written in the database by implementing a method to search for consensus among storage nodes. An example of such a method is the known method called proof-of-work (POW). The content of the database is thus protected against falsification despite its distributed nature.

The most famous blockchain database is that used in the transaction system of Bitcoin® electronic money. The Bitcoin® system database contains a history of all previous transactions carried out between the user accounts in the system. The need to use a centralized entity such as a bank to authenticate transactions is thus removed.

A client element storing a user's private keys and enabling transactions to be carried out in the blockchain database is called a wallet. Although most wallets are client software installed on a personal terminal (computer, smartphone) or on a remote server, some wallets, called “hardware wallets”) take the form of a physical object such as a USB token, which store keys autonomously (and separately from the network) to provide a higher security level.

One wallet task is to verify if a given transaction has been published in a Bitcoin blockchain. In the case of a blockchain database implementing a search for consensus by proof-of-work, such as Bitcoin, this verification consists of checking that a POW has been calculated correctly, i.e. that the hash value of a block whereof a portion has already been determined has a specific form, namely that it starts with a given number of zeros. For further verifications in Bitcoin, it is possible to request a POW be checked on several blockchains. For other blockchain databases, this verification may be that of a cryptographic signature.

Although such verification does not generally present a problem for a complex device such as a computer or smartphone mobile terminal, a small microcontroller such as a USB token or chip card does not have either the required connectivity nor the computing power to carry out the verification (a Bitcoin block can be 1 MB). For this reason, hardware wallets always have to be connected to a computer, which may not be a trusted computer, in order to be used.

It would therefore be desirable to enable simple devices such as a chip card to be used as the wallet for the blockchain databases, so as to enable transactions to be carried out just as easily as with a bank card and without any risk of piracy.

### BRIEF DESCRIPTION OF THE INVENTION

According to a first aspect, the present invention thus relates to a method for verifying a transaction in a blockchain database, the method being characterized in that it comprises the following steps:

(b) generation by a device of a proof of the fact that there is a valid block published in said database, such as said block contains descriptive data of said transaction;
(c) transmission of at least said proof to a client device;
(d) verification by the client device that the proof is valid.

According to other advantageous and non-limiting characteristics:

the descriptive data of said transaction contained in said block comprise at least one piece of transaction identification data, step (c) further comprises the transmission to the client device of said transaction identification data, and step (d) comprises the verification of said identification data transmitted for the transaction;

said transaction is issued by the client device, the verification of said identification data transmitted for the transaction comprising the verification of said that it matches a piece of transaction identification data as issued by the client device;

the descriptive data of said transaction contained in said block also comprises a piece of random data, step (c) further comprises the transmission to the client device of said random data, and step (d) comprising the verification of said identification data transmitted from the transaction corresponds to a random data defined by the client device;

said random data is inserted by the client device into a suitable transaction field, in particular an OP_RETURN field;

said transaction identification data is chosen from among a transaction identifier, a transaction signature by means of a private key of a user of the client device, a hash value of a public key for a beneficiary of the transaction, an identifier of a previous transaction to the transaction;

step (b) also comprises the transmission to the client device of a candidate hash value, said proof also being a proof of the fact that an identifier of said block has said candidate hash value as its hash value;

the method comprises a step (a) for publishing said transaction in the blockchain database by a transaction validation device;

step (a) comprises the generation of said block containing the descriptive data of said transaction and its addition to said blockchain database;

step (a) comprises the prior verification of the validity of said transaction by the transaction validation device, and step (b) comprises the verification by the proof device that said block containing descriptive data of said transaction is valid;

the verification of the validity of said block comprises the verification that a criterion specific to the blockchain database is verified by the hash value of an n-tuple of at least one nonce associated with the block and a fragment of the block content, or by a signature of the block;

said proof is a zero-knowledge proof, in particular a zkSNARK cryptographic object;

the client device is a chip card.

According to a second aspect, the invention relates to an assembly for verifying a transaction in a blockchain database, comprising a client device and a connected proof device, characterized in that:

The proof device is configured to generate a proof of the fact that there is a valid block published in said database, such as said block containing descriptive data of said transaction, and to transmit at least said proof to the client device;

the client device is configured to verify that the proof is valid.

According to other advantageous and non-limiting characteristics, the assembly further comprises a transaction validation device configured to publish said transaction in the blockchain database.

According to a third and fourth aspects, the invention relates to a computer program product comprising code instructions for the execution of a method according to the first aspect of verifying a transaction in a blockchain database, when said method is executed on a computer; and a storage means readable by computer equipment whereon a computer program product comprises code instructions for executing a method according to the first aspect of verifying a transaction in a blockchain database.

### DESCRIPTION OF THE FIGURES

Other characteristics, goals, and advantages of the invention will become clear from the following description, which is purely illustrative and non-limiting, which must be read in the context of the attached drawings in which:

FIG. 1 is a schematic representation of a system for verifying a transaction, according to one embodiment.

FIG. 2 is a flowchart of the steps of a method for verifying a transaction implemented by the system shown in FIG. 1, according to one embodiment.

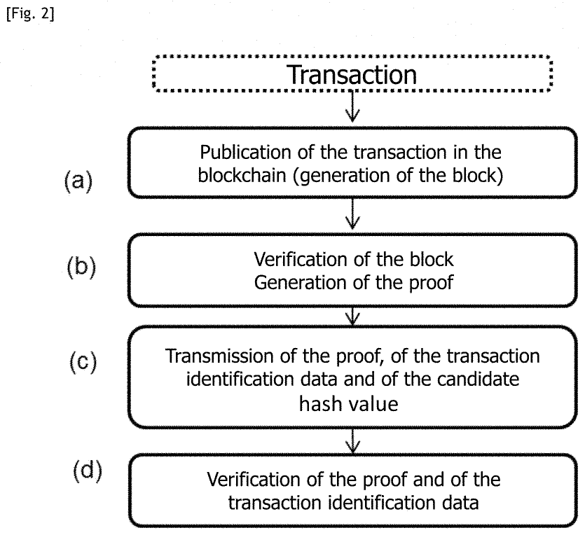

In the set of figures, similar elements are marked with identical references.

### DETAILED DESCRIPTION OF THE INVENTION

Architecture

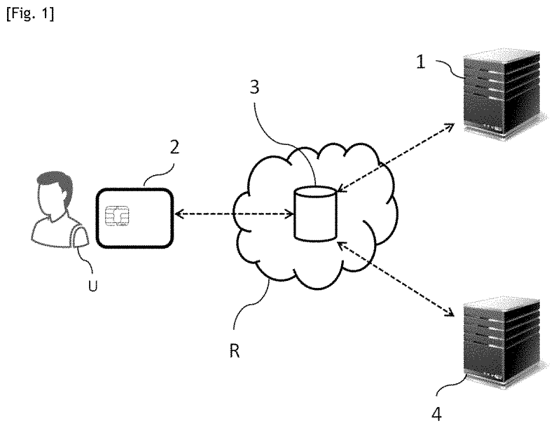

With reference to FIG. 1, a transaction system comprises at least one transaction validation device 1, called a “mining device”, at least one client device 2, called a “wallet” (generally a large number of them). In the context of the present method, a proof device 4 is added to it.

The devices 1, 2, 4 communicate with each another by means of at least one network N, for example, the internet, a cellular network, or a combination of such networks.

The devices 1 and 2 each have read and write access to a blockchain database 3 stored in the network N (read access is enough for the proof device 4). It is entirely possible for a device such as a personal computer to be both a transaction validation device 1 and a client device 2; similarly a transaction validation device 1 can also be the proof device 4, etc.

The database 3 is public, in the sense that read access to it is available not only for the devices 1, 2 and 4, but also to any other third-party device. In particular, any third-party device can consult data written by one of the devices 1, 2 and 4.

The transaction validation device 1 thus has read and write access to the database 3. To this end, the transaction validation device 1 memorizes two mutually associated keys: a private signature key specific to the device 1, and a public verification key that is also specific to the device 1. The private key enables the device 1 to write signed data in the database; it is not intended to be communicated to third parties. The public key enables the device 1 (and any other holder of an account to access the database 3) to verify that a piece of data present in the database 3 has been written therein by the device 1.

The client device 2 also has an account for read and write access to the database 3. Just like the transaction validation device 1, the client device 2 memorizes a mutually associated public key and private key that are specific thereto. Generally, the client device 2 is designated by an address that is typically a hash value of its public key.

“Hash value” (also called “condensate”) of a piece of data is obtained by applying a cryptographic hashing function to the data (typically of SHA-1 or SHA-2 families, in particular SHA-256). The hash value is of fixed size and does not reveal anything about the data from which it is issued: this data cannot be retrieved from its hash value, in any case not while the hashing function used is considered as secure. However, the hash value can be recalculated from the data in order to verify that it is correct.

The database 3 is distributed or decentralized in the network N, i.e. it is stored by a plurality of nodes in the network N, with which the devices 1, 2 and 4 can communicate.

As explained, the database 3 is a blockchain database. In the present text, a blockchain database is defined as a database memorized by a plurality of storage nodes configured to validate the data written in the database by implementing a method to search for consensus among the storage nodes. An example of such a method is the known method called proof-of-work (POWW). The content of the database 3 is thus protected against falsification despite its distributed/decentralized nature. Each block generally has:

a block content (or payload), generally consisting of descriptive data for a set of transactions;

a block head (or header), containing descriptive data of the block itself, i.e. information such as a block identifier, an identifier of the previous block in the blockchain, a nonce, a version number, a timestamp, a level of difficulty, etc.

The following description takes the example of a database 3 compliant with that used in the Bitcoin® transaction system. Thus, representative data of a transaction between two client devices 2 for a certain amount in Bitcoins is likely to be memorized in the database 3.

Each of the devices 1, 2, and 4 comprises at least one processor configured to process data calculations and a communication interface to communicate with the other devices and the database 3.

The main function carried out by the transaction validation device 1 is to mine new blocks in said blockchain. Each time a set of transactions is validated, it constitutes a block. If this block fulfills certain criteria specific to the blockchain for the transaction system (see below), it is then added to the top of the chain and the transaction validation device 1 that constituted this block is rewarded for its work. Each transaction validation device 1 is typically a dedicated server.

The client device 2 is a personal device of a user U, enabling them to carry out transactions in their own name, for example to send or receive Bitcoins. In the present case, the client device 2 is preferably a light physical device such as a chip card or a secure element (SE) of a terminal such as a smartphone, i.e. a dedicated closed, enclave-type microprocessor. It will be understood that the present invention is not limited to these examples and that the client device 2 can always be a smartphone, a touch tablet, a personal computer, etc.

The proof device 4 is typically a server of a security solution provider (SSP), commercial organization, etc., advantageously a trusted device.

### Method for Verifying a Transaction

Verification of a transaction is understood as the verification that this transaction has been published in a block of said blockchain, and verification of the validity of at least this block (and possibly of the previous blocks in the blockchain, typically six blocks).

For convenience in the rest of the present description, verification of the transaction will be considered as having been requested at the level of the client device 2 that issued it (i.e. the same user U issued the transaction and wishes to verify that it has been taken into account correctly and non-fraudulently), although in practice any transaction can be verified due to the public nature of the blockchain database 3.

An account for read and write access to the database 3 is assumed to have been created for the user U. Creating the account consists of allocating to the user the two previously mentioned mutually associated keys: a private signature key specific to the user U and a public signature verification key, which is also specific to the user U.

The two keys of the user U are memorized in a memory of the client device 2 at the user's request and/or are predetermined.

In the following description, any piece of data written in the database 3 at the request of an entity holding an account to access the database 3 is implicitly signed before being written by means of the private key specific to this entity. Furthermore, any signed data read in the database 3 by a third party holding an account to access the database 3 is implicitly verified by means of the public key specific to the entity, such as to obtain the data originally supplied by the entity.

Said signature, called ScriptSig for Bitcoin, is for example carried out by using elliptic-curve cryptography (ECC). In the present case, the secp256k1 curve is used in the Bitcoin system.

Generally, any transaction is defined by a set of descriptive data for the transaction, comprising at least one indication of the transaction amount and an “output”, i.e. the public key or at least the hash value of this public key, called scriptPubKey for Bitcoin, of the beneficiary (the one that receives a certain amount of a monetary unit such as Bitcoins). There may be several outputs, each associated with an amount.

Advantageously, the descriptive data for a transaction further includes an “input”, i.e. the identifier, called previous tx for Bitcoin, of one or more previous transactions (i.e. whose beneficiary is the issuer of the present transaction), with a large enough output amount to cover the transaction, i.e. proving the availability of funds that are the object of the transaction. A transaction always balances its inputs and outputs.

The issuer can then easily verify that:

the issuer has the public key hashing into the hash value entered in the output of said previous transaction, and

the issuer's signature matches this public key (and hence that the issuer has the matching private key).

In the rest of the present description, a piece of identification data is described as any piece of data from said descriptive data enabling the transaction to be identified, in particular a unique identifier Txid, the signature ScriptSig, the hash value of the beneficiary's public key scriptPubKey, and/or the identifier of the previous translation Previous tx.

Preferably, the descriptive data for the transaction also comprises a piece of random data inserted by the client device 2. Random data is understood as a piece of data serving no purpose for the transaction but which the client device 2 can define and thus verify the presence thereof later. Preferably, the random data can be a pseudo-random value, and can be inserted into a suitable field, in particular the OP_RETURN field existing in Bitcoin transactions (with a size of 80 bytes).

Preferably, the present method starts with a step (a) consisting of publishing the transaction to be verified, assumed to have been issued by a client device 2 (generally the client device 2 requesting verification of the transaction, as explained), having then requested memorization, in the database 3, of the descriptive data for the transaction.

As explained, this step (a) is implemented by the transaction validation device 1 and advantageously comprises the verification of the validity of the representative data for the transaction, so as to check that the transaction is not fraudulent (verification of the issuer's signature, of the existence of the beneficiary and, if necessary, of the availability of funds, and also that the transaction is not already in another block). If this is the case, step (a) preferably further comprises the generation and addition to said blockchain database 3 of a new block consisting of the descriptive data for a set of transactions comprising said transaction data to be validated, i.e. assembling this set of transactions as block content, such that any third party accessing the database 3 can see the existence of the transaction once this block is published. In the example of Bitcoin, transactions are stored in the form of a Merkle tree within a block (in its content). The header is then added to the block, which is the most complex part.

Typically, this part consists of determining the value of a nonce associated with the block (and generally the values of the block header), so that a specific criterion of the blockchain for the transaction system is verified.

This criterion is preferably at least a function of the nonce and of a fragment of the block content, in particular a condition in a hash value of an n-tuple of at least said nonce and the fragment of the block content, in particular the fact (in the case of Bitcoin) that said hash value starts with a certain number of zeros depending on the current level of difficulty. The present method is not limited to this embodiment, and the condition could for example include a block signature.

Said fragment of block content is advantageously an indirect trace of the set of transactions in the block, for example the tree root of the block transactions if they are stored in the form of a Merkle tree.

Said hash value of an n-tuple of at least said nonce and the fragment of block content advantageously consists of a block identifier.

Preferably, said n-tuple advantageously further comprises the identifier of the previous block and is in a particularly preferred way it concerns a sextuple consisting of:

the version number,

the hash value of the previous block,

said fragment of the block content (tree root of the block transactions),

the timestamp (for example, the time in seconds that has elapsed since midnight on Jan. 1, 1970),

the level of difficulty,

the nonce.

In practice, step (a) is attempted simultaneously by a large number of transaction validation devices 1; determining the correct value for the nonce generally consists of testing a large number of values until the criterion is verified. Once the correct value of the nonce has been determined, all the above data can be entered into the block header and this block submitted to other transaction validation devices 1, which verify its validity (by verifying said criterion, i.e. by recalculating said hash value of an n-tuple of at least said nonce and fragment of block content) before broadcasting it in turn and adding it into the database 3 following the chain. The transaction validation device 1 is then remunerated, and the other transaction validation devices 1 have to return to work on a new block.

At this stage, the block generated in step (a) is public and the transactions it contains can be seen by everyone, including the client devices 2.

As explained, although it is much easier to verify a block than to determine the correct value of the nonce (and is hence trivial for transaction validation devices 1 with high computing power), this verification can be too onerous for a very simple client device 2 such as a chip card.

The present method cleverly proposes to make the client device 2 verify not the validity of the block but simply a proof of the fact that a valid block has been published in said database 3, such as said block contains descriptive data of said transaction.

More specifically, it still remains possible to directly verify the validity of a block in a conventional way, but in the present method the client device 2 receives said proof that exempts it from this verification.

A proof is understood as a mathematical proof and, more specifically, a zero-knowledge proof. Zero-knowledge proofs have traditionally been used to avoid interactivity. More specifically, the proof provides guaranteed ownership of data without any need to transmit these data, which may be sensitive (e.g. biometric data, the proof revealing nothing apart from the fact that these biometric data are owned by the proof producer).

The Pinocchio protocol presented in the publication “Bryan Parno, Craig Gentry, Jon Howell, and Mariana Raykova, Pinocchio: Nearly Practical Verifiable Computation, in Proceedings of the IEEE Symposium on Security and Privacy, IEEE, 21 May 2013” was one of the first verifiable calculation protocols for enabling the implementer to verifiably compute the application of any function and the order giver to verify the associated proof within a calculation time less than what is needed to perform the calculation itself.

Thus, in step (b) the proof device 4 generates a proof of the fact that there is a valid block published in said database 3, such as said block contains descriptive data of said transaction.

More specifically, said proof guarantees the following statement: “given at least one piece of identification data for a transaction to be verified, a blockchain exists such that:

the block is valid,

said identification data of the transaction appears in the block”.

Thus, it is possible to check the existence of such a block and hence of the transaction's validity without needing to verify this block. The cryptographic protocol provides a quick (less than half a second) proof to be verified and that cannot be falsified: it is almost impossible (probability of less than 1/280, or even of less than 1/2128 depending on the parameters chosen to produce the proof, the latter then being slower to produce) for a proof of the statement above to be accepted if the process is not carried out in accordance with the specifications.

Naturally, step (b) advantageously comprises the prior verification by the proof device 4 that said block containing descriptive data of said transaction is valid, verifying the criterion laid down, typically by recalculating the hash value of the n-tuple of at least the nonce and the fragment of the transaction data contained, as explained above. It should be noted that verification of the block's validity can also comprise verification of the syntax and semantics of the block, i.e. verification that the block is formed in accordance with the blockchain specifications.

Step (b) can beforehand comprise identification of this block by searching for said transaction identification data. The data in all the blocks are public and a simple text search enables the right block to be found.

It is therefore understood that it is enough for the proof device 4 to have access to the blockchain database 3, and for the client device to have sent it said identification data of the transaction to be verified.

Particularly preferably, said proof is also a proof of the fact that an identifier of said block (containing descriptive data of said transaction to be verified) has a given hash value (called “candidate”) as its hash value.

The proof is therefore more specifically a zero-knowledge proof due to the fact that, given a candidate hash value and a piece of identification data for the transaction to be verified, there is a valid block published in said database 3, such as said block contains descriptive data of said transaction, and that an identifier of said block has said candidate hash value as its hash value.

This provides an additional level of security regarding the proof.

### Generation of Proof

Preferably, said (zero-knowledge) proof is a zkSNARK cryptographic object.

zkSNARK means “zero-knowledge Succinct Non-Interactive Argument of Knowledge”, i.e. Argument of non interactive knowledge with zero divulgation of knowledge. It involves a cryptographic primitive constructed about the idea of proof. Researchers in theoretical computer science and cryptography have long been interested in the idea of proof. There are theoretical results allowing a very short, secure proof to be produced from an algorithm, but the time for producing such proof is out of reach and will remain so in spite of the increase in computing power of computers. One of the reasons lies in the power given to the entity that produces the proof, the proof device 4 (also called the prover). In the theoretical results on proofs, the prover has infinite computing power and the proofs remain secure in spite of this.

The idea of proof was then relaxed, the protocol seeking only to protect itself from a prover that would have significant but limited computing power. The result of the protocol is no longer a proof but an argument. It is from this idea of argument that practical systems of verifiable calculation are constructed. An additional requirement in a system producing an argument is that said argument not be interactive: the verifier and the prover do not need to interact in order to produce the argument.

zkSNARKS have been presented since 2010: this involves arguments of short size (a few features of an elliptical curve), which do not need interactivity and which in addition enable the prover to perform a zero-knowledge proof, i.e. the proof does not contain any non-trivial information about the inputs furnished by the prover.

There are several protocols that actually produce zkSNARKs, and a person skilled in the art will be able to use them interchangeably in the present method:

The Pinocchio protocol, already mentioned;

The Gepetto protocol, presented in the publication “Craig Costello, Cedric Fournet, Jon Howell, Markulf Kohlweiss, Benjamin Kreuter, Michael Naehrig, Bryan Parno, and Samee Zahur, Geppetto: Versatile Verifiable Computation, in Proceedings of the IEEE Symposium on Security and Privacy, IEEE, 18 May 2015,” which is an improvement of the Pinocchio method;

The protocol presented in that and in subsequent publications “Eli Ben-Sasson, Alessandro Chiesa, Daniel Genkin, Eran Tromer, Madars Virza. SNARKs for C: Verifying Program Executions Succinctly and in Zero Knowledge. In Proceedings of the 33rd Annual International Cryptology Conference, CRYPTO '13, pages 90-108, 2013,” implemented open-source in the form of a library called libsnark, optimizing the protocol producing a zkSNARK in Pinocchio by improving the expressivity, i.e. the type of programs or algorithm that can be verified.

Taking the Pinocchio protocol as an example, this protocol contains several parts:

1. A conventional program is translated in the form of an arithmetic circuit, i.e. a set of relations between the inputs and outputs of the program that are translated solely by means of additions and multiplications of features of a finite body. It should be noted that in theory all the programs can be translated in this form, but only a portion of these programs allows effective translation into circuit form.
2. The arithmetic circuit obtained is represented effectively by means of three families of polynomials to which one additional polynomial is added, called target polynomial. These families of polynomials form “Quadratic Arithmetic Programs” (QAPs). They encode the relations between the inputs and outputs of each multiplication gate of the circuit, the relations of the addition gates being integrated into the first multiplication gate that follows in the calculation.

Said QAPs are connected to the verifiable calculation by the following point: a calculation y=C(x) is correct for an input x if and only if all the relations describing the corresponding arithmetic circuit are satisfied by setting x as input value and y as output value.

In some way, the QAPs make it possible to compress all the constraints to be verified into a single relationship to be verified: a polynomial constructed from the value x and three families of the QAP must divide the target polynomial.

3. A cryptographic protocol then takes a QAP as input associated with a program, generates evaluation and verification keys that use elliptical curves to conceal the polynomial relations. The polynomial proving that the calculation has been correctly performed is then computed directly by means of the relations concealed in the elliptical curve. The divisibility relation is translated only by means of a constant number of features of the elliptical curve, i.e. the proof is of constant size. The verification of said proof is extremely quick.

In addition, the protocol makes it possible to ensure that inputs from the calculation furnished by the prover are private: it enables the values of the prover to be concealed in the production of the proof by multiplying them by a multiple of the target polynomial, which does not change the fact that the “proof polynomial” is divisible by the target polynomial.

Said “proof” polynomial, whereupon it is concealed in an elliptical curve, constitutes a zkSNARK.

The Pinocchio protocol enables the zkSNARK that performs the proof to conceal some of the inputs of the calculation by which the proof is being done. In this case, it involves producing the following calculation:

Input: candidate hash values, the result of verifying the validity of the block (i.e. a Boolean), the descriptive data of the transaction and an initialization vector IV.

Private input: the block content

Output: the proof π that the prover knows the valid block, the identifier thereof hashing into said candidate hash value, and contains said descriptive data of said transaction.

It should be noted that protocols are known that are provided for the generation of a proof of proper operation of a hashing function, that the skilled person will be able to use directly even if they are not optimal. The difficulty is in obtaining a reasonable calculation time for producing the proof, and evaluation and verification key sizes that are not excessive.

The Zerocash protocol (IEEE Security & Privacy 2014) of Ben-Sasson et al., proposes the definition of an arithmetic circuit in order to verify the compression function of SHA-256, which includes about 30,000 multiplication gates. This gives a proof production time of about 5 seconds (per compression level, verifying the full hashing function, which comprises numerous iterations of the compression function will be considerably longer), which remains high and significantly improvable.

The ZKBoo protocol, presented in the publication “ZKBoo: faster zero-knowledge for boolean circuits” by Giacomelli, Madsen and Orlandi (Usenix Security 2016) enables better performance (proof in 50 ms, verification in 70 ms) per iteration of the compression function, but the size of the proof is significant (800 KB), especially since it only seems to have been measured on an application of the compression function.

### The Rest of the Method

In step (c), the proof device 4 transmits said proof to the client device 2, and possibly said transaction identification data and/or the candidate hash value. The block per se is not to be transmitted.

In step (d), the client device 2 verifies that the proof is valid. If said transaction identification data used is transmitted, the client device 2 also verifies it (i.e. checks that said transaction identification data transmitted matches that of the transaction as issued by the client device 2).

If this is the case, the user U knows that the transaction is valid.

The verification of the proof in step (d) is not interactive (the client device 2 does not need to contact the proof device 1) and is simply done in constant time by verifying that the proof is valid, which demonstrates (with a tiny probability) to the client device 2 that the claimed ownership is true, i.e. that there is a valid block published in said database 3, such as said block contains descriptive data of said transaction, despite the absence of the content of this block.

The proof is short (indeed very short—approximately a few hundred bytes), transmitting it with the various data presents no bandwidth problem. Furthermore, it is easy to verify this proof, which is compatible, if necessary, with the limited computing power of the client device 2. Generating the proof is more onerous in terms of computing time, but since step (b) is implemented by the proof device 4, this additional computing time is not problematic.

### Equipment

According to a second aspect, an assembly is proposed for verifying a transaction in a blockchain database 3 to implement the method according to the first aspect.

The assembly comprises at least one client device 2, a proof device 4 and, if necessary, at least one transaction validation device 1.

The proof device 4, which is typically a trusted server, is configured to generate a proof (in particular, a zero-knowledge proof) of the fact that there is a valid block published in said database 3, such as said block contains descriptive data of said transaction, and to transmit at least said proof to the client device 2.

The verification device 2 is configured to verify that the proof is valid.

The possible transaction validation device 1 configured to publish said transaction in the blockchain database 3, and the proof device 4 can be configured to verify the validity of this block.

### Computer Program Product

According to a third and fourth aspects, the invention relates to a computer program product comprising code instructions for the execution (in particular on the data processing means of devices 1, 2, 4) of a method according to the first aspect of the invention for verifying a transaction in a blockchain database 3, as well as storage means readable by computer equipment (a memory of the entities 1, 2, 4) whereon said computer program product is located.

1. A method for verifying a transaction in a blockchain database, the method being characterized in that it comprises the following steps:
(b) generation by a proof device of a proof of the fact that there is a valid block published in said database, such as said block contains descriptive data of said transaction;
(c) transmission of at least said proof to a client device;
(d) verification by the client device that the proof is valid.

2. A method according to claim 1, wherein the descriptive data of said transaction contained in said block comprise at least one piece of transaction identification data, step (c) further comprises transmission to the client device of said transaction identification data, and step (d) comprises the verification of said transaction identification data transmitted.

3. A method according to claim 2, wherein said transaction is issued by the client device, the verification of said identification data transmitted for the transaction comprising the verification that it matches a piece of transaction identification data as issued by the client device.

4. A method according to claim 3; wherein the descriptive data of said transaction contained in said block also comprises a piece of random data, step (c) further comprises transmission to the client device of said random data, and step (d) comprising the verification said identification data transmitted from the transaction matches a piece of random data defined by the client device.

5. A method according to claim 4 wherein said random data is inserted by the client device (2) into a suitable field for the transaction, in particular an OP_RETURN field.

6. A method according to claim 2, wherein said transaction identification data is chosen from among a transaction identifier, a transaction signature by means of a private key of a user of the client device, a hash value of a public key of a beneficiary of the transaction, an identifier of a previous transaction to the transaction.

7. A method according to claim 1, wherein step (b) also comprises the transmission to the client device of a candidate hash value, said proof also being a proof of the fact that an identifier of said block has said candidate hash value as its hash value.

8. A method according to claim 1, comprising a step (a) of publication of said transaction in the blockchain database by a transaction validation device.

9. A method according to claim 8, wherein step (a) comprises the generation of said block containing descriptive data of said transaction and its addition to said blockchain database.

10. A method according to claim 9, wherein step (a) comprises the prior verification of the validity of said transaction by the transaction validation device, and step (b) comprises the verification by the proof device that said block containing the descriptive data of said transaction is valid.

11. A method according to claim 10, wherein verifying the validity of said block comprises the verification that a criterion specific to the blockchain database is verified by the hash value of an n-tuple of at least one nonce associated with the block and a fragment of the block content, or by a signature of the block.

12. A method according to claim 1, wherein said proof is a zero-knowledge proof, in particular a zkSNARK cryptographic object.

13. A method according to claim 1, wherein the client device is a chip card.

14. An assembly for verifying a transaction in a blockchain database comprising a client device and a connected proof device connected, characterized in that:
The proof device is configured to generate a proof of the fact that there is a valid block published in said database, such as said block contains descriptive data of said transaction; and to transmit at least said proof to the client device;
the client device is configured to verify that the proof is valid.

15. An assembly according to claim 14, further comprising a transaction validation device configured to publish said transaction in the blockchain database.

16. A non-transitory computer program product comprising code instructions for the execution of a method according to claim 1 for verifying a transaction in a blockchain database, when code instructions are executed on a computer.

17. A non-transitory storage means whereon a computer program product comprises code instructions for the execution of a method according to claim 1 for verifying a transaction in a blockchain database.
